(19) United States
(12) Patent Application Publication
(10) Pub. No.: US 2008/0184003 A1
(43) Pub. Date: Jul. 31, 2008

(54) DATA TRANSMISSION CONTROL APPARATUS AND DATA TRANSMISSION CONTROL METHOD

(75) Inventor: Takeru Ono, Tagata-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,578

(22) Filed: Jan. 30, 2007

(51) Int. Cl. G06F 13/10

(52) U.S. Cl. 711/170

(57) ABSTRACT

A data transfer control apparatus applicable to an image forming apparatus according to an embodiment of the invention includes a first storing unit configured to store data, a second storing unit configured to store data, a temporary storing unit configured to temporarily store data transferred from the first storing unit to the second storing unit or from the second storing unit to the first storing unit, and a transfer control unit configured to select, according to a characteristic of transfer data, one transfer processing of first transfer processing for directly transferring the transfer data from the first storing unit to the second storing unit or from the second storing unit to the first storing unit and second transfer processing for indirectly transferring the transfer data from the first storing unit to the second storing unit or from the second storing unit to the first storing unit via the temporary storing unit and control transfer of the transfer data.

### BACKGROUND OF THE INVENTION

1. Field of the Invention

The present invention relates to a data transmission control apparatus and a data transmission control method applicable to image forming apparatuses that are capable of performing various kinds of image formation such as a copier, a printer, and a FAX.

2. Description of the Related Art

In recent years, various image forming apparatuses represented by an MFP (Multi Function Printer) are spread. The MFP can collectively treat image data digitized by various functions such as a copier, a printer, a scanner, and a FAX, store these image data in an HDD, and reuse the image data. The HDD can store not only the image data but also various control data (job management data and parameters).

In general, data read from and data write in the HDD are performed through a file system. Therefore, application software does not need to recognize a physical access position of the data recorded in the HDD and is capable of accessing the data recorded in the HDD by designating a partition name, a folder name, and a file name. The file system determines an area (an address) in use in the HDD from information such as a file name designated by the application software and executes data transfer between the area and a transfer destination (source) memory designated by the application software. In an operation of the file system, in order to improve file access efficiency, data transfer between a transfer destination (source) memory designated by the application software and the HDD may be performed through a cache (a memory) of the file system. This is data transfer for performing, between the memory and the cache, exchange of the data with the application software and reducing the frequency of access to the HDD. At the time of reading, the frequency of access to the HDD is lower as a hit ratio of the file system cache is higher. At the time of writing, the frequency of access to the HDD is reduced by storing a certain degree of data in the file system cache and transferring the data to the HDD only when necessary. The file system cache effectively works on data of a small volume (not exceeding a cache size) with high frequency of writing in and reading from the HDD and data written in a unit of a large number of small blocks.

However, depending on a type of data to be treated, the file system cache does not always effectively work. Conversely, transfer efficiency may be deteriorated by transferring data through the file system cache. For example, when image data of a large volume far exceeding a capacity of the file system cache is continuously written, the frequency of access to the HDD is not reduced even if the data is once stored in the cache and then transferred to the HDD. Since the data is copied from a memory of application software to the cache, useless processing is performed. The same problem occurs when a large volume of data is continuously read from the HDD.

As described above, in the conventional system, since the file system cache does not always effectively work depending on data to be treated, it is desired to perform optimum HDD access corresponding to a characteristic of data.

### BRIEF SUMMARY OF THE INVENTION

It is an object of the invention to provide a data transfer control apparatus and a data transfer control method excellent in data transfer efficiency.

A data transfer control apparatus applicable to an image forming apparatus according to an aspect of the invention comprises a first storing unit configured to store data, a second storing unit configured to store data, a temporary storing unit configured to temporarily store data transferred from the first storing unit to the second storing unit or from the second storing unit to the first storing unit, and a transfer control unit configured to select, according to a characteristic of transfer data, one transfer processing of first transfer processing for directly transferring the transfer data from the first storing unit to the second storing unit or from the second storing unit to the first storing unit and second transfer processing for indirectly transferring the transfer data from the first storing unit to the second storing unit or from the second storing unit to the first storing unit via the temporary storing unit and control transfer of the transfer data.

A data transfer control method applicable to an image forming apparatus according to another aspect of the invention comprises selecting, according to a characteristic of transfer data, one transfer processing of first transfer processing for directly transferring the transfer data from the first storing unit to the second storing unit or from the second storing unit to the first storing unit and second transfer processing for indirectly transferring the transfer data from the first storing unit to the second storing unit or from the second storing unit to the first storing unit via a temporary storing unit and controlling transfer of the transfer data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of a schematic structure of an image forming apparatus (an MFP);

FIG. 2 is a block diagram showing an example of a software configuration for realizing access to a file in an HDD;

FIG. 3 is a block diagram showing an example of a hardware configuration for realizing data transfer between the HDD and a memory;

FIG. 4 is a diagram showing an example of data transfer not employing a file cache;

FIG. 5 is a diagram of an example of data transfer employing the file cache; and

FIG. 6 is a flowchart showing an example of cache-use determination processing.

### DETAILED DESCRIPTION OF THE INVENTION

An embodiment will be explained with reference to the drawings.

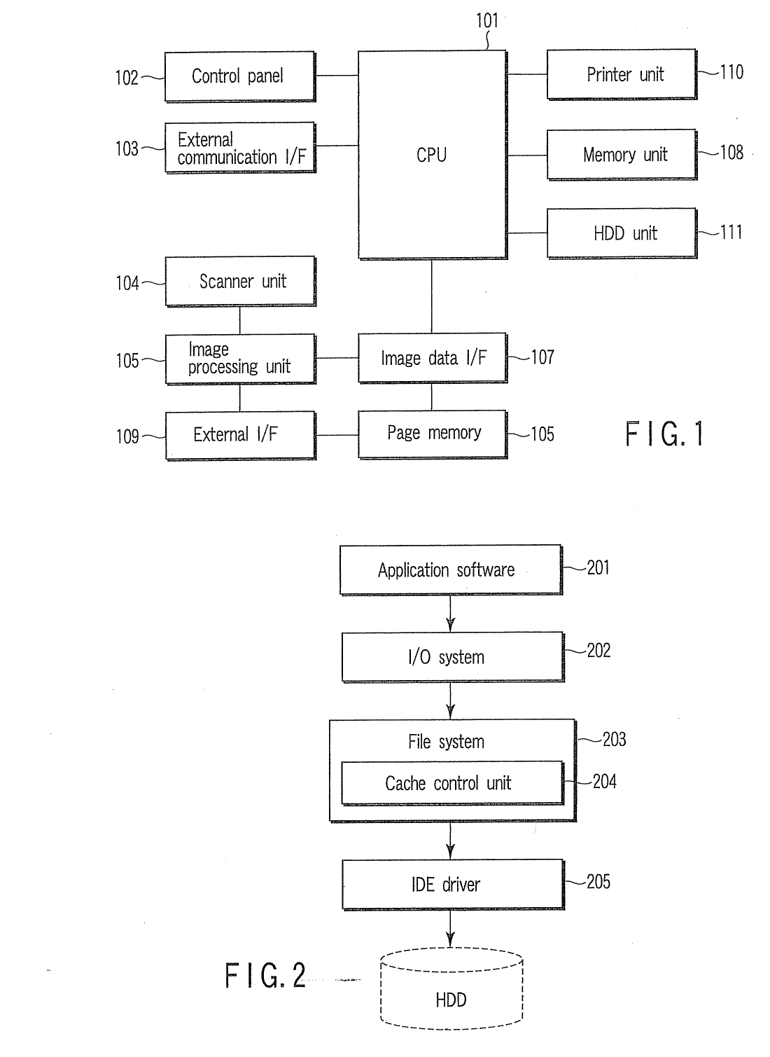

FIG. 1 is a diagram showing a schematic structure of an image forming apparatus (an MFP).

A CPU 101 that controls the entire image forming apparatus scans, in response to a print request from a user sent through a control panel 102 or an external communication interface (I/F) 103, an image with a scanner unit 104 when it is necessary to scan the image, subjects image data obtained by the scanning of the image to image processing with an image processing unit 105, and stores the image data subjected to the image processing in a page memory 106. Image data transferred via an external I/F 109 is also stored in the page memory 106. These kinds of processing are controlled by the CPU 101 through an image data interface (I/F) 107. The image data stored in the page memory 106 is sent to a printer unit 110 via the image data I/F 107 and the CPU 101. The printer unit 110 forms an image based on the image data. In other words, the printer unit 110 records the image based on the image data on a sheet.

A memory unit 108 and a hard disk drive (HDD) unit 111 (a first storing unit) store image data and control data (job management data and parameters) at predetermined timing. The CPU 101 controls data transfer from the memory unit 108 to the HDD unit 111 or from the HDD unit 111 to the memory unit 108.

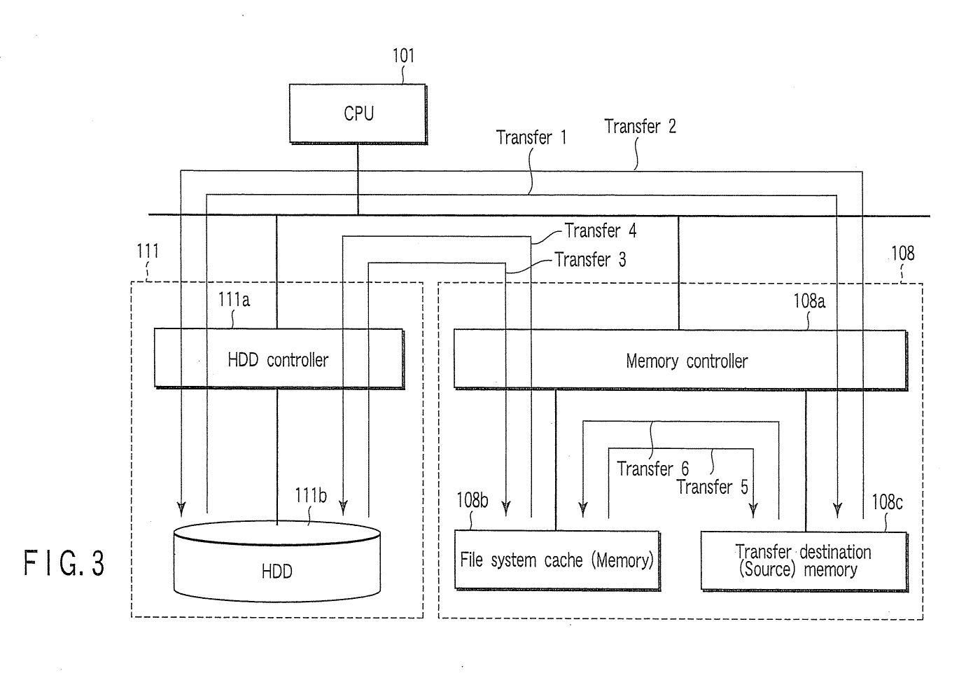

FIG. 2 is a block diagram showing an example of a software configuration for realizing access to a file in an HDD. FIG. 3 is a block diagram showing an example of a hardware configuration for realizing data transfer between the HDD and a memory. As shown in FIG. 3, the memory unit 108 includes a memory controller 108a, a file system cache (a memory) 108b (a temporary storing unit), and a transfer destination and transfer source memory 108c (a second storing unit). The HDD unit 111 includes an HDD controller 111a and an HDD 111b.

In accessing a file in the HDD 111b, an application software 201 shown in FIG. 2

requests file open designating a partition name, a folder name, or a file name in the HDD 111b,

requests read designating a transfer destination memory address and a transfer size,

requests write designating a transfer source memory address and a transfer size, and

request file close.

The I/O system 202 communicates these requests to a file system 203. The file system 203, which has received these requests, executes data transfer between the HDD 111b and the memory 108c designated by the application software 201 while controlling the file system cache with the cache control unit 204. As a pattern of the data transfer executed by the file system 203, four patterns (A) to (D) described below are conceivable.

(A) When HDD data is read not through the file system cache, a read request is sent to an IDE driver 205 such that data transfer indicated by transfer 1 in FIG. 3 is executed.

(B) When HDD data is written not through the file system cache, a write request is sent to the IDE driver 205 such that data transfer indicated by transfer 2 in FIG. 3 is executed.

(C) When HDD data is read through the file system cache, a read request is sent to the IDE driver 205 such that data transfer indicated by transfer 3 in FIG. 3 is executed. Thereafter, data transfer indicated by transfer 5 is performed. However, when requested data is already present in the file system cache in FIG. 3, the transfer request indicated by transfer 3 in FIG. 3 is not performed and only the transfer indicated by transfer 5 is executed. Consequently, the frequency of access to the HDD is reduced and overall data transfer efficiency is improved.

(D) When HDD data is written through the file system cache, after data transfer indicated by transfer 6 in FIG. 3 is performed, a write request is sent to the IDE driver 205 such that data transfer indicated by transfer 4 is executed. However, according to a state of the file system cache, it is possible to improve the overall data transfer efficiency by holding down the frequency of execution of the transfer indicated by transfer 4 as much as possible.

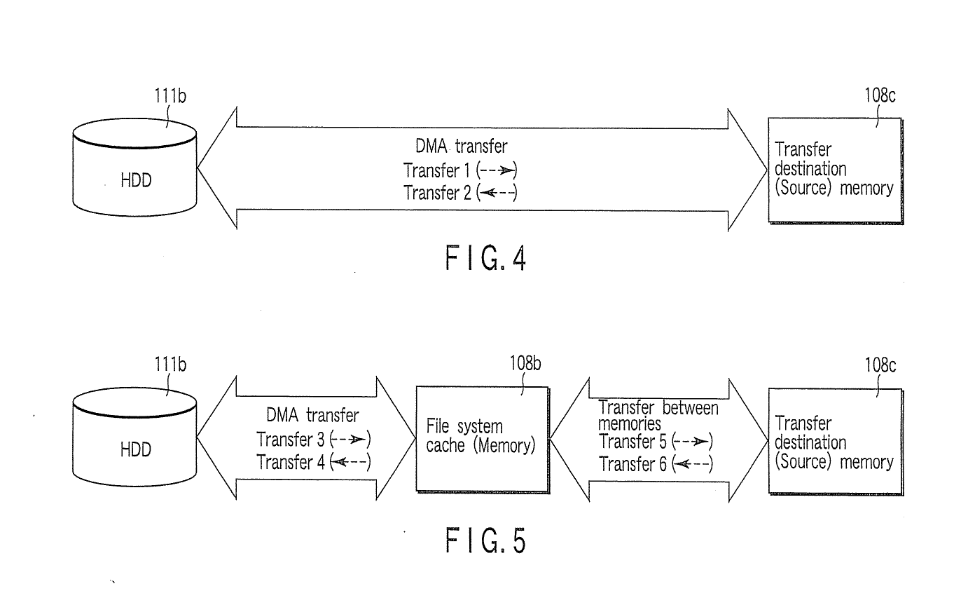

FIG. 4 is a diagram showing data transfer corresponding to the patterns (A) and (B). FIG. 5 is a diagram showing data transfer corresponding to the patterns (C) and (D).

As shown in FIG. 4, in the patterns (A) and (B), DMA transfer is directly performed between the memory 108c and the HDD 111b. On the other hand, as shown in FIG. 5 in the patterns (C) and (D), the memory 108c performs data transfer with the file system cache 108b and DMA transfer is performed between the HDD 111b and the file system cache 108b when necessary.

An advantage of the data transfer shown in FIG. 4 is that, since the DMA transfer is directly performed between the HDD 111b and the memory 108c, useless data copy is not performed. A disadvantage is that, since access to the HDD 111b is always performed in response to a file access request from the application software 201, it is likely that the frequency of access to the HDD 111b increases and overall file access efficiency falls.

An advantage of the data transfer shown in FIG. 5 is that, since data transfer responding to a file access request from the application software 201 is performed between the file system cache 108b and the memory 108c as much as possible to control access to the HDD 111b to a minimum limit, it is possible to improve overall file access efficiency. A disadvantage is that the file system cache 108b does not effectively work depending on a type of data to be treated and, when the frequency of access to the HDD 111b is the same as those in the data transfer shown in FIG. 4, file access efficiency falls because data transfer between the file system cache 108b and the memory 108c increases compared with the data transfer shown in FIG. 4.

Consequently, in order to efficiently perform file access, rather than always performing data transfer employing the file system cache 108b, use or nonuse of the file system cache 108b is determined according to a type (a characteristic) of data to be treated (data as a transfer object).

In this embodiment, in the case of file access to various data, a type of data is discriminated and use or nonuse of the file system cache 108b is determined on the basis of prior information on whether the file system cache 108b effectively works.

Examples of data to be treated (data as a transfer object) include the following data.

Image data

Job management data (control data)

Various parameters (control data)

The image data generally has a large volume. The application software 201 does not repeatedly access the image data in a state in which the image data is stored in the file system cache 108b. Therefore, as shown in FIG. 4, it is more efficient to directly DMA-transfer the image data between the HDD 111b and the memory 108c.

The job management data and the various parameters are data, contents of which are highly likely to be updated in a unit of a small block and data of which once read is highly likely to be reused in the application software 201. Therefore, as shown in FIG. 5, access employing the file system cache 108b is efficient.

Consequently, use or nonuse of the file system cache 108b is determined according to whether data to be accessed is image data or control data.

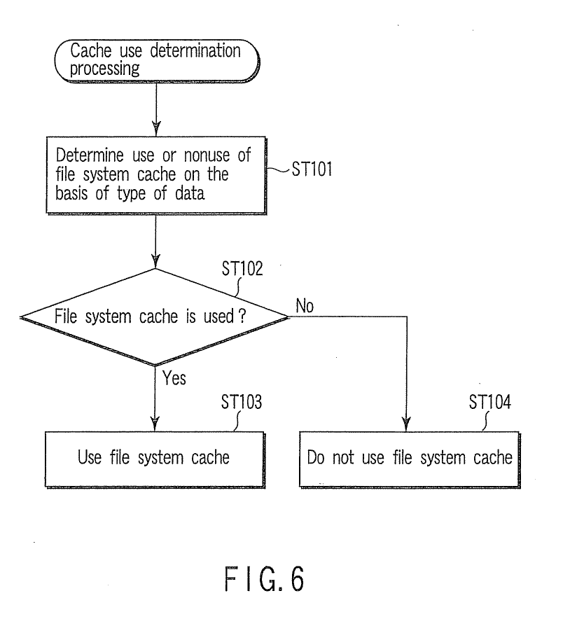

FIG. 6 is a flowchart showing an example of cache use determination processing by the cache control unit 204. The cache control unit 204 discriminates a type of data to be accessed (data as a transfer object) and determines use or nonuse of the file system cache 108b (ST101). When the data to be accessed (the data as a transfer object) is image data, the cache control unit 204 determines that the file system cache 108b is used (ST102, YES) and uses the file system cache 108b (ST103). When the data to be accessed (the data as a transfer object) is control data, the cache control unit 204 determines that the file system cache 108b is not used (ST102, NO) and does not use the file system cache 108b (ST104).

Examples of a method of discriminating a type of data are described below.

(1) The cache control unit 204 discriminates a type of data on the basis of an extension of a file designated by the application software 201. It is registered in advance that a specific extension is used for a file name of image data. Therefore, the cache control unit 204 discriminates whether the data is image data or other data (control data) on the basis of whether the extension is the extension used in the image data file. The cache control unit 204 transfers, according to the data transfer processing shown in FIG. 4, transfer data identified as image data on the basis of the extension of the file. The cache control unit 204 transfers, according to the data transfer processing shown in FIG. 5, transfer data identified as control data on the basis of the extension of the file.

(2) The cache control unit 204 discriminates a type of data on the basis of a folder name designated by the application software 201. It is registered in advance that an image data file is stored in a specific folder. Therefore, the cache control unit 204 discriminates whether the data is image data or other data (control data) on the basis of whether the folder name is the folder name with which the image data file is stored. The cache control unit 204 transfers, according to the data transfer processing shown in FIG. 4, transfer data identified as image data on the basis of the folder name. The cache control unit 204 transfers, according to the data transfer processing shown in FIG. 5, transfer data identified as control data on the basis of the folder name.

(3) The cache control unit 204 discriminates a type of data on the basis of a file name designated by the application software 201. It is registered in advance that a specific file name is set for an image data file. Therefore, the cache control unit 204 discriminates whether the data is image data or other data (control data) on the basis of whether the file name is the file name of the image data file. The cache control unit 204 transfers, according to the data transfer processing shown in FIG. 4, transfer data identified as image data on the basis of the file name. The cache control unit 204 transfers, according to the data transfer processing shown in FIG. 5, transfer data identified as control data on the basis of the file name.

(4) The cache control unit 204 discriminates a type of data on the basis of whether an access area (a partition name) of the HDD 111b designated by the application software 201 is an area dedicated to an image data file. It is registered in advance that an image data file is stored in a specific area of the HDD 111b. Therefore, the cache control unit 204 discriminates whether the data is image data or other data (control data) on the basis of whether the access area (the partition name) of the HDD 111b is the area dedicated to the image data file. The cache control unit 204 transfers, according to the data transfer processing shown in FIG. 4, transfer data identified as image data on the basis of the access area (the partition name). The cache control unit 204 transfers, according to the data transfer processing shown in FIG. 5, transfer data identified as control data on the basis of the access area (the partition name).

(5) The cache control unit 204 discriminates a type of data on the basis of whether a memory address of a transfer destination (source) designated by the application software 201 is a memory address dedicated to an image data file. It is registered in advance that an image data dedicated memory is used. Therefore, the cache control unit 204 discriminates whether the data is image data or other data (control data) on the basis of whether the memory address of the transfer destination (source) is the memory address dedicated to the image data file. The cache control unit 204 transfers, according to the data transfer processing shown in FIG. 4, transfer data identified as image data on the basis of the memory address. The cache control unit 204 transfers, according to the data transfer processing shown in FIG. 5, transfer data identified as control data on the basis of the memory address.

(6) The cache control unit 204 discriminates a type of data on the basis of whether an access block size designated by the application software 201 is larger than a reference value. It is registered in advance that image data is accessed in a unit of a block of a size larger than the reference value. Therefore, the cache control unit 204 discriminates whether the data is image data or other data (control data) on the basis of whether the access block size is larger than the reference value. The cache control unit 204 transfers, according to the data transfer processing shown in FIG. 4, transfer data identified as image data on the basis of the access block size. The cache control unit 204 transfers, according to the data transfer processing shown in FIG. 5, transfer data identified as control data on the bass of the access block size.

Consequently, it is possible to realize efficient HDD file access corresponding to a data type. In this embodiment, it is explained that the file system cache is not used only at the time of data transfer of image data. However, it is possible to determine a data type and a condition of cache use or nonuse according to a system. In this embodiment, the case in which the cache control unit 204 in FIG. 2 determines cache use or nonuse described in FIG. 6 is explained. However, the application software 201 may determine cache use/nonuse and give an instruction to the cache control unit 204. Moreover, the file system cache 108b is explained as being under the control by the file system 203 shown in FIG. 2. However, the file system cache 108b may be placed under the control by the application software 201 or the IDE driver 205. In this case, as in the above case, the determination of cache use or nonuse described in FIG. 6 may be performed in any one of the application software 201, the file system 203, and the IDE driver 205.

As explained above, in the conventional HDD file access, the file system cache is used regardless of a type of data. Thus, depending on a type of data, file access efficiency is deteriorated when the data is transferred through the file system cache. According to this embodiment, a type of data to be accessed (data as a transfer object) is discriminated and use or nonuse of the file system cache is determined on the basis of prior information on whether the file system cache effectively works. Consequently, it is possible to realize efficient HDD file access corresponding to a type of data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transfer control apparatus applicable to an image forming apparatus, comprising:
a first storing unit configured to store data;
a second storing unit configured to store data;
a temporary storing unit configured to temporarily store data transferred from the first storing unit to the second storing unit or from the second storing unit to the first storing unit; and
a transfer control unit configured to select, according to a characteristic of transfer data, one transfer processing of first transfer processing for directly transferring the transfer data from the first storing unit to the second storing unit or from the second storing unit to the first storing unit and second transfer processing for indirectly transferring the transfer data from the first storing unit to the second storing unit or from the second storing unit to the first storing unit via the temporary storing unit and control transfer of the transfer data.

2. A data transfer control apparatus applicable to an image forming apparatus according to claim 1, wherein the transfer control unit selects one transfer processing of the first transfer processing and the second transfer processing on the basis of an extension of a file of transfer data.

3. A data transfer control apparatus applicable to an image forming apparatus according to claim 1, wherein the transfer control unit transfers, according to the first transfer processing, transfer data identified as image data on the basis of an extension of a file of the transfer data and transfers, according to the second transfer processing, transfer data identified as control data on the basis of an extension of a file of the transfer data.

4. A data transfer control apparatus applicable to an image forming apparatus according to claim 1, wherein the transfer control unit selects one transfer processing of the first transfer processing and the second transfer processing on the basis of a stored folder name with which transfer data is stored.

5. A data transfer control apparatus applicable to an image forming apparatus according to claim 1, wherein the transfer control unit transfers, according to the first transfer processing, transfer data identified as image data on the basis of a stored folder name with which the transfer data is stored and transfers, according to the second transfer processing, transfer data identified as control data on the basis of a stored folder name with which the transfer data is stored.

6. A data transfer control apparatus applicable to an image forming apparatus according to claim 1, wherein the transfer control unit selects one transfer processing of the first transfer processing and the second transfer processing on the basis of a file name of transfer data.

7. A data transfer control apparatus applicable to an image forming apparatus according to claim 1, wherein the transfer control unit transfers, according to the first transfer processing, transfer data identified as image data on the basis of a file name of the transfer data and transfers, according to the second transfer processing, transfer data identified as control data on the basis of a file name of the transfer data.

8. A data transfer control apparatus applicable to an image forming apparatus according to claim 1, wherein the transfer control unit selects one transfer processing of the first transfer processing and the second transfer processing on the basis of an access area of the first storing unit to be a transfer source or a transfer destination of transfer data.

9. A data transfer control apparatus applicable to an image forming apparatus according to claim 1, wherein the transfer control unit transfers, according to the first transfer processing transfer, data identified as image data on the basis of an access area of the first storing unit to be a transfer source or a transfer destination of the transfer data and transfers, according to the second transfer processing, transfer data identified as control data on the basis of an access area of the first storing unit to be a transfer source or a transfer destination of the transfer data.

10. A data transfer control apparatus applicable to an image forming apparatus according to claim 1, wherein the transfer control unit selects one transfer processing of the first transfer processing and the second transfer processing on the basis of an address of the second storing unit to be a transfer source or a transfer destination of transfer data.

11. A data transfer control apparatus applicable to an image forming apparatus according to claim 1, wherein the transfer control unit transfers, according to the first transfer processing, transfer data identified as image data on the basis of an address of the second storing unit to be a transfer source or a transfer destination of the transfer data and transfers, according to the second transfer processing, transfer data identified as control data on the basis of a transfer destination address of the transfer data.

12. A data transfer control apparatus applicable to an image forming apparatus according to claim 1, wherein the transfer control unit selects one transfer processing of the first transfer processing and the second transfer processing on the basis of an access block size for accessing transfer data.

13. A data transfer control apparatus applicable to an image forming apparatus according to claim 1, wherein the transfer control unit transfers, according to the first transfer processing, transfer data identified as image data on the basis of a fact that an access block size for accessing the transfer data is larger than a reference size and transfers, according to the second transfer processing, transfer data identified as control data on the basis of a fact that the access block size is equal to or smaller than the reference size.

14. A data transfer control method applicable to an image forming apparatus comprising:
selecting, according to a characteristic of transfer data, one transfer processing of first transfer processing for directly transferring the transfer data from the first storing unit to the second storing unit or from the second storing unit to the first storing unit and second transfer processing for indirectly transferring the transfer data from the first storing unit to the second storing unit or from the second storing unit to the first storing unit via a temporary storing unit and controlling transfer of the transfer data.

15. A data transfer control method according to claim 14, wherein transfer data corresponding to image data is transferred according to the first transfer processing and transfer data corresponding to control data is transferred according to the second transfer processing.

16. A data transfer control apparatus applicable to an image forming apparatus, comprising:
first storing means for storing data;
second storing means for storing data;
temporary storing means for temporarily storing data transferred from the first storing means to the second storing means or from the second storing means to the first storing means; and
transfer control means for selecting, according to a characteristic of transfer data, one transfer processing of first transfer processing for directly transferring the transfer data from the first storing means to the second storing means or from the second storing means to the first storing means and second transfer processing for indirectly transferring the transfer data from the first storing means to the second storing means or from the second storing means to the first storing means via the temporary storing means and controlling transfer of the transfer data.

17. A data transfer control apparatus according to claim 16, wherein the transfer control means transfers transfer data corresponding to image data according to the first transfer processing and transfers transfer data corresponding to control data according to the second transfer processing.
